(19) United States
(12) Patent Application Publication
(10) Pub. No.: US 2026/0275179 A1
(43) Pub. Date: Sep. 17, 2026

(54) ALPHA ALUMINA-BASED CERAMIC MATERIAL AND METHODS OF MAKING SAME

(71) Applicant: 3M INNOVATIVE PROPERTIES COMPANY, St. Paul, MN (US)

(72) Inventors: Anatoly Z. Rosenflanz, Maplewood, MN (US); Jason D. Anderson, Richfield, MN (US)

(21) Appl. No.: 19/473,160

(22) PCT Filed: May 13, 2024
(86) PCT No.: PCT/IB2024/054637

§ 371 Date: Oct. 7, 2025

Related U.S. Application Data
(60) Provisional application No. 63/506,849, filed on Jun. 8, 2023.

(51) Int. Cl. C09K 3/14; C04B 35/117; C04B 35/626; C04B 35/628; C04B 35/64

(52) U.S. Cl. CPC C09K 3/1418; C04B 35/117; C04B 35/6261; C04B 35/6268; C04B 35/62813; C04B 35/62886; C04B 35/64; C04B 2235/3222; C04B 2235/443; C04B 2235/95

(57) ABSTRACT

The present disclosure provides an alpha alumina-based ceramic material. The alpha alumina-based ceramic material (100) includes numerous domains (120) including alpha alumina and a reaction product of alumina and at least one metal oxide different from alumina and exhibits a density of greater than 90% of theoretical. The present disclosure also provides a method of making an alpha alumina-based ceramic material. The method includes pressing aluminum hydroxide precursor powder under applied pressure, thereby forming a compacted body, and converting the compacted body to an alpha alumina-based ceramic precursor material. The method further includes impregnating the alpha alumina-based ceramic precursor material with an impregnating composition containing at least one metal oxide precursor and/or at least one metal oxide and converting the impregnated alpha alumina-based ceramic precursor material to an alpha alumina-based ceramic material.

### BACKGROUND

Alpha alumina-based ceramic materials having an ultrafine microstructure (e.g., a grain size of less than 1 micrometer) are known, for instance having use in the abrasives industry. Further developments in alpha alumina-based ceramic materials would be desirable.

### SUMMARY

In a first aspect, an alpha alumina-based ceramic material is provided. The alpha alumina-based ceramic material includes a number of domains including alpha alumina and a reaction product of alumina and at least one metal oxide different from alumina. The domains have a shortest dimension of 5 to 80 micrometers. The alpha alumina-based ceramic material exhibits a density of greater than 90% of theoretical.

In a second aspect, a method of making an alpha alumina-based ceramic material is provided. The method includes pressing aluminum hydroxide precursor powder selected from the group consisting of boehmite powder, gibbsite powder, bayerite powder, and combinations of thereof, under applied pressure of greater than 5 kilopounds per square inch (ksi) (34 megapascals (MPa)), thereby forming a compacted body, and converting the compacted body to an alpha alumina-based ceramic precursor material. The method further includes impregnating the alpha alumina-based ceramic precursor material with an impregnating composition containing at least one metal oxide precursor, at least one metal oxide, or any combinations thereof, and converting the impregnated alpha alumina-based ceramic precursor material to an alpha alumina-based ceramic material. The alpha alumina-based ceramic material exhibits a density of greater than 90% of theoretical.

These aspects advantageously provide dense ceramic materials that do not require dispersion of a powder of an alpha alumina-based ceramic precursor material to make the ceramic materials.

The above summary of the present disclosure is not intended to describe each disclosed embodiment or every implementation of the present disclosure. The description that follows more particularly exemplifies illustrative embodiments. In several places throughout the application, guidance is provided through lists of examples, which examples can be used in various combinations. In each instance, the recited list serves only as a representative group and should not be interpreted as an exclusive list.

### BRIEF DESCRIPTION OF THE DRAWINGS

FIG. 1A is a scanning electron microscopy (SEM) image of a portion of the ceramic material of Example 12, at a magnification of 700×.

FIG. 1B is an SEM image of a portion of the ceramic material of Example 12, at a magnification of 10,000×.

FIG. 1C is an SEM image of a portion of the ceramic material of Example 12, at a magnification of 1,900×.

FIG. 2A is an SEM image of a portion of the ceramic material of Example 1, at a magnification of 10,000×.

FIG. 2B is an SEM image of a portion of the ceramic material of Example 1, at a magnification of 500×.

While the above-identified figures set forth several embodiments of the disclosure other embodiments are also contemplated, as noted in the description. The figures are not necessarily drawn to scale. In all cases, this disclosure presents aspects of the invention by way of representation and not limitation.

### DETAILED DESCRIPTION

### Glossary

As used herein, “ceramic” refers to a non-metallic material that is produced by application of heat. Ceramics are usually hard and brittle and, in contrast to glasses or glass-ceramics, display an essentially purely crystalline structure. Ceramics are usually classified as inorganic materials. “Crystalline” means a solid composed of atoms arranged in a pattern periodic in three dimensions (i.e., has long-range crystal structure which may be determined by techniques such as X-ray diffraction). A “crystallite” means a crystalline domain of a solid having a defined crystal structure. A crystallite can only have one crystal phase.

As used herein, “alpha alumina-based ceramic material” refers to a sintered, polycrystalline ceramic material that has been sintered to a density of greater than 90% (preferably, at least 92%, more preferably, at least 94%, or even at least 95% or 97%) of theoretical, and contain, on a theoretical metal oxide basis, at least 60% by weight Al₂O₃, wherein at least 50% by weight of the Al₂O₃ is present as alpha alumina.

As used herein, “boehmite” refers to alpha alumina monohydrate, and boehmite is commonly referred to in the art as “pseudo” boehmite (i.e., Al₂O₃·xH₂O, wherein x=1 to 2).

As used herein, “gibbsite” refers to Al(OH)₃ having a structure of stacked octahedral sheets of aluminum hydroxide.

As used herein, “bayerite” refers to Al(OH)₃ that is a polymorph of gibbsite due to having a somewhat different arrangement of hydroxyl groups.

As used herein, “impregnating material” refers to metal oxide(s) and/or precursor(s) thereof.

As used herein, “converting” with regard to making the precursor material, refers to any step or series of steps that provide the precursor material, and may include crushing and/or calcining.

As used herein, “ceramic precursor material” or “unsintered ceramic material” refers to ceramic precursor material or calcined ceramic precursor material, which is typically in the form of particles that have a density of less than 80% (typically less than 60%) of theoretical and are capable of being sintered and/or impregnated with an impregnation composition and then sintered to provide alpha alumina-based ceramic material.

As used herein, “domain” with respect to a ceramic material refers to a discrete volume of material that differs from another volume of material in at least one of the following: metal oxide content, residual porosity, grain size, or grain morphology.

As used herein, “shortest dimension” with respect to a domain refers to a smallest distance across the domain volume that passes through a center of the domain.

As used herein, “abrasive grain” refers to materials in the form of particles having a Mohs hardness of at least 8 (preferably, at least 9).

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure.

In this application, terms such as “a”, “an”, and “the” are not intended to refer to only a singular entity, but include the general class of which a specific example may be used for illustration. The terms “a”, “an”, and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The term “and/or” means one or all of the listed elements or a combination of any two or more of the listed elements.

Also herein, all numbers are assumed to be modified by the term “about” and preferably by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used.

As used herein as a modifier to a property or attribute, the term “generally”, unless otherwise specifically defined, means that the property or attribute would be readily recognizable by a person of ordinary skill but without requiring absolute precision or a perfect match (e.g., within +/−20% for quantifiable properties). The term “substantially”, unless otherwise specifically defined, means to a high degree of approximation (e.g., within +/−10% for quantifiable properties) but again without requiring absolute precision or a perfect match. Terms such as same, equal, uniform, constant, strictly, and the like, are understood to be within the usual tolerances or measuring error applicable to the particular circumstance rather than requiring absolute precision or a perfect match.

It has unexpectedly been discovered that dense ceramic materials can be prepared including dry pressing aluminum hydroxide precursor powder instead of having to form a dispersion of the aluminum hydroxide precursor powder.

### Ceramic Materials

In a first aspect, an alpha alumina-based ceramic material is provided. The alpha alumina-based ceramic material comprises a plurality of domains comprising alpha alumina and a reaction product of alumina and at least one metal oxide different from alumina, the domains comprising a shortest dimension of 5 to 80 micrometers, wherein the alpha alumina-based ceramic material exhibits a density of greater than 90% of theoretical. In select embodiments, the alpha alumina-based ceramic material exhibits a density of greater than 92%, 93%, 94%, 95%, 96%, or greater than 97% of theoretical. Density may be measured using a gas pycnometer, as known in the art.

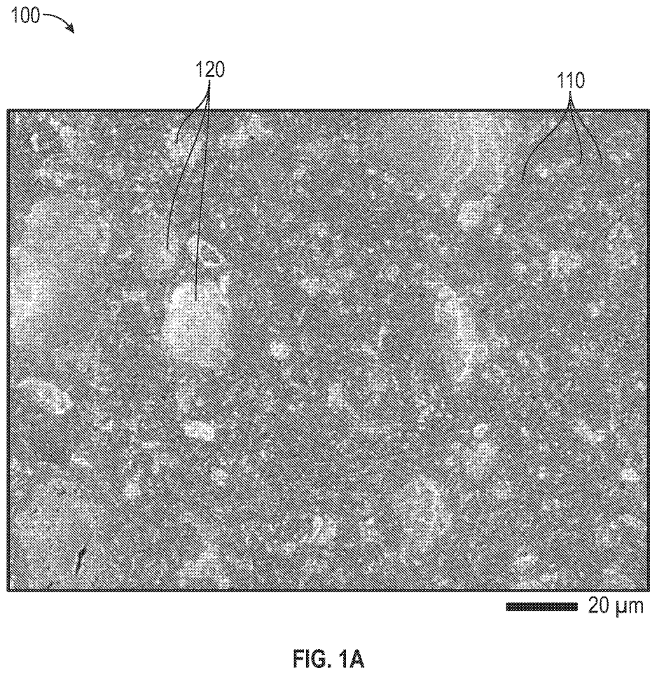

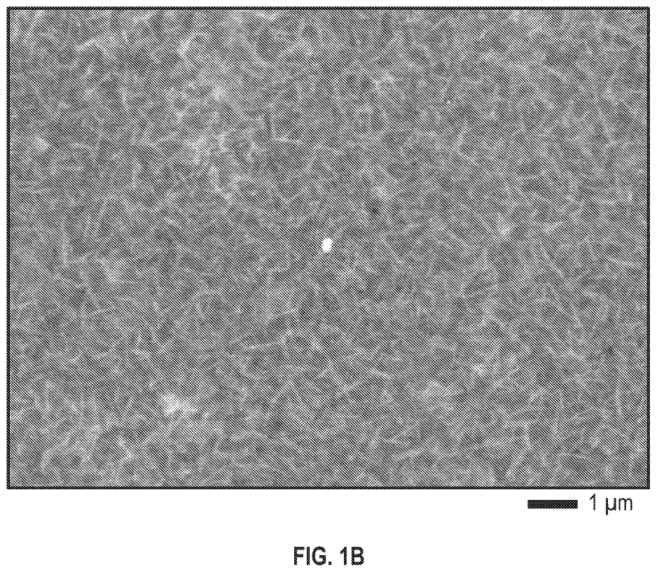

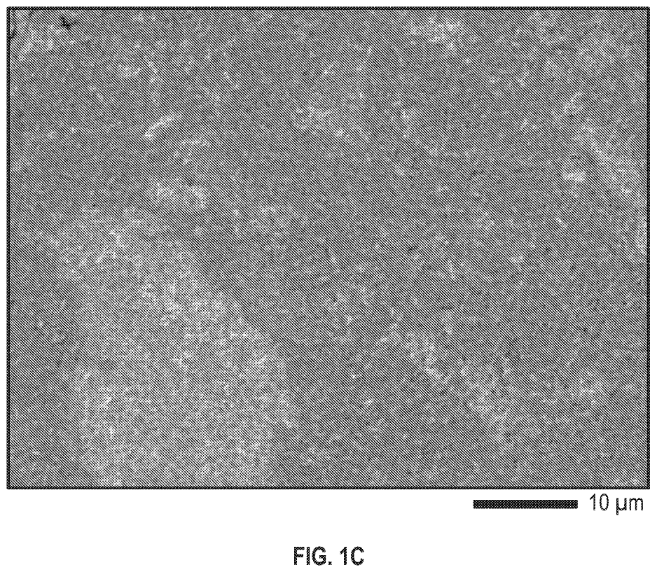

Referring to FIG. 1A, a scanning electron microscopy (SEM) image of a portion of the ceramic material 100 of Example 12 shows an alpha alumina-based ceramic matrix 110 comprising alpha alumina and a phase formed by a reaction of alumina and a metal oxide different from alumina. Said ceramic further contains domains 120 in which a concentration of alpha alumina and the phase formed by a reaction of alumina and a metal oxide different from alumina are different from that of the matrix 110. It is noted that the domains appear in the SEM images as a brighter or lighter-colored area than the alpha alumina-based ceramic matrix. In this case, the domains 120 include a lower concentration of alpha alumina and a higher content of the reaction product of alumina and at least one metal oxide different from alumina than the alpha alumina-based ceramic matrix 110. Stated another way, the ceramic matrix 110 contains a higher content of alumina and a lower content of the reaction product of alumina and at least one metal oxide different from alumina than the domains 120.

The domains include at least some domains that have a shortest dimension of 5 micrometers or greater, 7 micrometers, 10 micrometers 12 micrometers, 15 micrometers, 17 micrometers, 20 micrometers, 22 micrometers, 25 micrometers, 27 micrometers, 30 micrometers, 32 micrometers, 35 micrometers, 37 micrometers, or 40 micrometers or greater; and 80 micrometers or less, 75 micrometers, 70 micrometers, 65 micrometers, 60 micrometers, 55 micrometers, 50 micrometers, 45 micrometers, or 40 micrometers or less. It is to be understood that there may additionally be some domains 120 of at least one metal oxide different from alumina that have a shortest dimension outside of the range of 5 micrometers to 80 micrometers.

Without wishing to be bound by theory, it is believed that the domains comprising alumina and a reaction product of alumina and a metal oxide different from alumina are formed due to the aluminum hydroxide precursor powder in its dry state, when being pressed, having agglomerates of varying particle size and porosity. In contrast, when aluminum hydroxide precursor powder is dispersed in water in a conventional method of making an alpha alumina-based ceramic material, the dispersion process causes deagglomeration of the particles of the aluminum hydroxide precursor and results in a homogeneous sol of crystallites of the aluminum hydroxide precursor. In the powder pressing methods disclosed herein, however, the agglomerates of the aluminum hydroxide precursor having varying size and porosity get pressed into a compacted body. When the compacted body is impregnated, the impregnating composition infiltrates the body inhomogeneously due to the variations of size and porosity of the compacted body.

Upon conversion of the impregnated alpha alumina-based ceramic precursor material to an alpha alumina-based ceramic material, the domains are formed. As noted above, domains differ from another volume of material in at least one of metal oxide content, residual porosity, grain size, or grain morphology. In the case of FIG. 1A discussed above, the domains differ from the matrix at least in metal oxide content; namely, metal oxide that is a reaction product of alumina and a metal oxide that is different from alumina. More particularly, relative concentrations of a) alumina and b) the reaction product of alumina and at least one metal oxide that is different from alumina vary between the matrix and the domains.

Typically, the reaction product of alumina and at least one metal oxide different from alumina, of the domains, present in an amount greater than 0.5 percent metal oxide, based on a total oxide content of the alpha alumina-based ceramic material. In some embodiments, the metal oxide, on a theoretical metal oxide basis, is greater than 0.75 percent, 1.0 percent, 1.25 percent, 1.5 percent, or even greater than 2 percent; and up to 10 percent by weight metal oxide, based on the total theoretical oxide content of the alpha alumina-based ceramic material.

The metal oxide is not particularly limited. In certain embodiments, the metal oxide is selected from the group consisting of MgO, CoO, NiO, Ce₂O₃, ZrO₂, HfO₂, Li₂O, MnO, Cr₂O₃, Y₂O₃, Pr₂O₃, Sm₂O₃, Yb₂O₃, Nd₂O₃, La₂O₃, Gd₂O₃, Dy₂O₃, Er₂O₃, Eu₂O₃, TiO₂, Fe₂O₃, SnO₂, ZnO, ZrO₂, and combinations thereof. In certain cases, the metal oxide is a combination of MgO, La₂O₃, and Y₂O₃.

A reaction product of alumina and at least one metal oxide that is different from alumina typically forms during a heat treatment step in which the impregnate precursor to the metal oxide may react with alumina to form a reaction product. For example, the oxides of cobalt, nickel, zinc, and magnesium typically react with alumina to form a spinel structure. Yttria typically reacts with alumina to form 3Y₂O₃·5Al₂O₃, which has the garnet crystal structure. Praseodymium, samarium, ytterbium, neodymium, lanthanum, gadolinium, cerium, dysprosium, erbium, and mixtures of two or more of these rare earth metals, typically react with alumina to form garnet, beta alumina, or phases exhibiting a perovskite structure. Certain rare earth oxides and divalent metal oxides react with alumina to form a rare earth aluminate represented by the formula LnMAl₁₁O₁₉, wherein Ln is a trivalent metal ion such as La, Nd, Ce, Pr, Sm, Gd, or Eu, and M is a divalent metal cation such as Mg, Mn, Ni, Zn, Fe, or Co. Such rare earth aluminates typically have a hexagonal crystal structure that is sometimes referred to as a magnetoplumbite crystal structure. Hexagonal rare earth aluminates generally have exceptional properties in an abrasive particle and if present, are typically within the abrasive particle as a whisker(s) or platelet(s). Such whiskers or platelets typically have a length of about 0.5 micrometer to about 1 micrometer, and a thickness of about 0.1 micrometer or less. These whiskers or platelets are more likely to occur in the absence of a nucleating agent.

In certain embodiments, the alpha alumina-based ceramic material has a form of a plurality of abrasive grains. In some cases, the abrasive grains have conchoidal fractures, which are shell-shaped fractures. The abrasive grains may be conchoidally fractured as a result of crushing or breaking the compacted body prior to firing, producing particles particularly suited for use as abrasive grains.

Abrasive grains can be used in conventional abrasive products, such as coated abrasive products, bonded abrasive products (including grinding wheels, cutoff wheels, and honing stones), nonwoven abrasive products, and abrasive brushes. Typically, abrasive products (i.e., abrasive articles) include binder and abrasive grains, at least a portion of which are abrasive grains made according to the present disclosure, secured within the abrasive product by the binder. Methods of making such abrasive products are well known to those skilled in the art. Furthermore, abrasive grains made according to the present disclosure can be used in abrasive applications that utilize slurries of abrading compounds (e.g., polishing compounds).

Coated abrasive products generally include a backing, abrasive grain, and at least one binder to hold the abrasive grains onto the backing. The backing can be any suitable material, including cloth, polymeric film, fiber, nonwoven webs, paper, combinations thereof, and treated versions thereof. The binder can be any suitable binder, including an inorganic or organic binder. The abrasive grains can be present in one layer or in two layers of the coated abrasive product. Preferred methods of making coated abrasive products are described, for example, in U.S. Pat. No. 4,734,104 (Broberg), U.S. Pat. No. 4,737,163 (Larkey), U.S. Pat. No. 5,203,884 (Buchanan et al.), U.S. Pat. No. 5,378,251 (Culler et al.), U.S. Pat. No. 5,417,726 (Stout et al.), U.S. Pat. No. 5,436,063 (Follett et al.), U.S. Pat. No. 5,496,386 (Broberg et al.), and U.S. Pat. No. 5,520,711 (Helmin), the disclosures of which are incorporated herein by reference.

The coated abrasive product can have an attachment means on its back surface to secure the coated abrasive product to a support pad or backup pad. Such attachment means can be, for example, a pressure sensitive adhesive or one side of a hook and loop attachment. The back side of the coated abrasive product may also contain a slip resistant or frictional coating. Examples of such coatings include an inorganic particulate material (e.g., calcium carbonate or quartz) dispersed in an adhesive.

Bonded abrasive products typically include a shaped mass of abrasive grains held together by an organic, metallic, or vitrified binder. Such shaped mass can be, for example, in the form of a wheel, such as a grinding wheel or cutoff wheel. It can also be in the form, for example, of a honing stone or other conventional bonded abrasive shape. It is preferably in the form of a grinding wheel. For further details regarding bonded abrasive products, see, for example, U.S. Pat. No. 4,997,461 (Markhoff-Matheny et al.), the disclosure of which is incorporated herein by reference. Preferred binders that can be used are curable at temperatures and under conditions that will not adversely affect the abrasive grain. Nonwoven abrasive products typically include an open porous lofty polymer filament structure having abrasive grains distributed throughout the structure and adherently bonded therein by an organic binder. Examples of filaments include polyester fibers, polyamide fibers, and polyaramid fibers. For further details regarding nonwoven abrasive products, see, for example, U.S. Pat. No. 2,958,593 (Hoover et al.), the disclosure of which is incorporated herein by reference.

Useful abrasive brushes including abrasive grains made according to the present disclosure include those having a plurality of bristles unitary with a backing (see, e.g., U.S. Pat. No. 5,679,067 (Johnson et al.), the disclosure of which is incorporated herein by reference). Preferably, such brushes are made by injection molding a mixture of polymer and abrasive grain.

Suitable organic binders for the abrasive products include thermosetting organic polymers.

Examples of suitable thermosetting organic polymers include phenolic resins, urea-formaldehyde resins, melamine-formaldehyde resins, urethane resins, acrylate resins, polyester resins, aminoplast resins having pendant alpha, beta-unsaturated carbonyl groups, epoxy resins, and combinations thereof. The binder and/or abrasive product can also include additives such as fibers, lubricants, wetting agents, thixotropic materials, surfactants, pigments, dyes, antistatic agents (e.g., carbon black, vanadium oxide, graphite, etc.), coupling agents (e.g., silanes, titanates, zircoaluminates, etc.), plasticizers, suspending agents, and the like. The amounts of these optional additives are selected to provide the desired properties. The coupling agents can improve adhesion to the abrasive grains and/or a filler.

The binder can also contain filler materials or grinding aids, typically in the form of a particulate material. Typically, the particulate materials are inorganic materials. Examples of particulate materials that act as fillers include metal carbonates, silica, silicates, metal sulfates, metal oxides, and the like. Examples of particulate materials that act as grinding aids include: halide salts such as sodium chloride, potassium chloride, sodium cryolite, and potassium tetrafluoroborate; metals such as tin, lead, bismuth, cobalt, antimony, iron, and titanium; organic halides such as polyvinyl chloride and tetrachloronaphthalene; sulfur and sulfur compounds; graphite; and the like. A grinding aid is a material that has a significant effect on the chemical and physical processes of abrading, which results in improved performance. In a coated abrasive product, a grinding aid is typically used in the supersize coat applied over the surface of the abrasive grain, although it can also be added to the size coat. Typically, if desired, a grinding aid is used in an amount of about 50-300 grams per square meter (g/m²) (preferably, about 80-160 g/m²) of coated abrasive product.

Abrasive grains made according to the methods of the present disclosure, can include a surface coating. Surface coatings are known to improve the adhesion between the abrasive grains and the binder in abrasive products, and in some cases to improve the abrading properties of the abrasive grain. Such surface coatings are, for example, described in U.S. Pat. No. 5,011,508 (Wald et al.), U.S. Pat. No. 5,009,675 (Kunz et al.), U.S. Pat. No. 4,997,461 (Markhoff-Matheny et al.), U.S. Pat. No. 5,213,591 (Celikkaya et al.), U.S. Pat. No. 5,085,671 (Martin et al.), and U.S. Pat. No. 5,042,991 (Kunz et al.), the disclosures of which are incorporated herein by reference.

The abrasive products can contain 100% abrasive grains made according to the method of the present disclosure, or they can contain a blend with conventional abrasive grains and/or diluent particles. However, at least about 5% by weight, and preferably about 30-100% by weight, of the abrasive grains in the abrasive products should be abrasive grains made according to the methods of the present disclosure. Examples of suitable conventional abrasive grains include fused aluminum oxide, silicon carbide, diamond, cubic boron nitride, garnet, fused alumina zirconia, and other sol-gel abrasive grain, and the like. Examples of suitable diluent particles include marble, gypsum, flint, silica, iron oxide, aluminum silicate, glass, and diluent agglomerates. Abrasive grains made according to the method of the present invention can also be combined in or with abrasive agglomerates. An example of an abrasive agglomerate is described in U.S. Pat. No. 4,311,489 (Kressner), U.S. Pat. No. 4,652,275 (Bloecher et al.), and U.S. Pat. No. 4,799,939 (Bloecher et al.), the disclosures of which are incorporated herein by reference.

Particles of the dried, calcined, and/or sintered materials provided during or by the method according to the present disclosure, may be screened and graded using techniques known in the art. For example, the particles are typically screened to a desired size prior to calcining. Sintered abrasive grain particles are typically screened and graded prior to use in an abrasive application or incorporation into an abrasive article. Screening and grading of abrasive grains made according to the method of the present invention can be done, for example, using the well-known techniques and standards for ANSI (American National Standard Institute), FEPA (Federation Europeenne des Fabricants de Products Abrasifs), or JIS (Japanese Industrial Standard) grade abrasive grain.

In certain embodiments, suitable abrasive grains have an average particle size of 0.5 millimeters (mm) or greater, 0.6 mm, 0.7 mm, 0.8 mm, 0.9 mm, 1.0 mm, 1.1 mm, 1.2 mm, 1.3 mm, 1.4 mm, or 1.5 mm or greater; and 5 mm or less, 4.8 mm, 4.6 mm, 4.4 mm, 4.2 mm, 4.0 mm, 3.8 mm, 3.6 mm, 3.4 mm, 3.2 mm, 3.0 mm, 2.8 mm 2.6 mm, 2.4 mm, 2.2 mm, or 2.0 mm or less.

Additional details regarding shaped abrasive grains are disclosed, for example, in U.S. Pat. No. 5,090,968 (Pellow), U.S. Pat. No. 5,201,916 (Berg et al.), U.S. Pat. No. 5,776,214 (Wood) and U.S. Pat. No. 5,779,743 (Wood), the disclosures of which are incorporated herein by reference.

Surprisingly, it was found that dense abrasive particles with grinding characteristics similar to that of conventional sol-gel derived particles could be prepared by cold-isostatically pressing dry powders, calcining the compacted body, crushing the compacted body into particles with a specified nominal grade, infiltrating with conventional solutions of rare-earth oxides, and sintering.

### Methods

In a second aspect, a method of making of making an alpha alumina-based ceramic material is provided. The method comprises:
a) pressing aluminum hydroxide precursor powder selected from the group consisting of boehmite powder (AlOOH), gibbsite powder (Al(OH)₃), bayerite powder (Al(OH)₃), and combinations thereof under applied pressure of greater than 5 kilopounds per square inch (ksi) (34 megapascals (MPa)), thereby forming a compacted body;
b) converting the compacted body to an alpha alumina-based ceramic precursor material;
c) impregnating the alpha alumina-based ceramic precursor material with an impregnating composition comprising at least one metal oxide precursor, at least one metal oxide, or any combinations thereof; and
d) converting the impregnated alpha alumina-based ceramic precursor material to an alpha alumina-based ceramic material,
wherein the alpha alumina-based ceramic material exhibits a density of greater than 90% of theoretical.

Suitable boehmite can be prepared using various techniques known in the art (see, e.g., U.S. Pat. No. 4,202,870 (Weber et al.) and U.S. Pat. No. 4,676,928 (Leach et al.), the disclosures of which are incorporated herein by reference). Suitable boehmite can also be obtained, for example, from commercial sources such as PIDC of Ann Arbor, MI (e.g., under the trade designation of “950”) or Sasol of Houston, TX (e.g., under the trade designations “DISPERAL”, “DISPAL”, “CATAPAL A”, “CATAPAL B”, and “CATAPAL D”). These aluminum oxide monohydrates are in the alpha form, and include relatively little, if any, hydrated phases other than monohydrates (although very small amounts of trihydrate impurities can be present in some commercial grade boehmite, which can be tolerated). They typically have a low solubility in water and have a high surface area (typically at least about 180 square meters per gram (m²/g)). Boehmite typically includes at least about 2-6 percent by weight free water (depending on the humidity) on its surface.

Preferably, the boehmite has an average ultimate particle size of less than about 20 nanometers (more preferably, less than about 12 nanometers), wherein “particle size” is defined by the longest dimension of a particle. The particle size may be determined using transmission electron microscopy (TEM).

Suitable gibbsite can be prepared via a conventional Bayer process using techniques known in the art (see, e.g., International Patent Publication Nos. WO 1994/018122 (Fulford et al.) and WO 1996/006043 (Rodda et al.) and European Patent No. EP 1206412B1 (Bilandzic et al.)). Suitable bayerite can be prepared using techniques known in the art (see, e.g., European Patent No. EP 1206412B1 (Bilandzic et al.) and U.S. Pat. No. 3,092,454 (Doelp).

In pressing the aluminum hydroxide precursor powder, it is understood that the powder is subjected to a pressure or force such as experienced, for example, in a pellitizer or die press (including mechanical, hydraulic and pneumatic or presses). In general, pressing the powder reduces the amount of air or gases entrapped in the powder, which in turn generally produces a less porous microstructure that is more desirable. The applied pressure is greater than 5 ksi (34 MPa), such as 7 ksi (48 MPa) or greater, 10 ksi (69 MPa), 12 ksi (83 MPa), 15 ksi (103 MPa), 20 ksi (138 MPa), 25 ksi (172 MPa), 30 ksi (207 MPa), 35 ksi (241 MPa), 40 ksi (276 MPa), 45 ksi (310 MPa), or 50 ksi (345 MPa) or greater. Often, the pressure is 100 ksi (689 MPa) or less, 90 ksi (621 MPa), 80 ksi (552 MPa), or 70 ksi (483 MPa) or less. Often, the pressing is performed uniaxially, but may instead be performed biaxially.

It may be preferred to select a pressing technique that provides a shaped mass (e.g., a rod, pyramid, triangular plate, diamond, or cone). For example, the powder can be pressed into a compacted body having a form of a rod. If the compacted body is a rod, it may have a diameter of, for example, about 150-5000 micrometers, and an aspect ratio (i.e., length to width ratio) of at least one, at least two, or at least five.

In some cases, the compacted body can be crushed or broken, or shredded and grated, to provide smaller sized particles. For example, in certain embodiments, the converting in step b) (i.e., converting the compacted body to an alpha alumina-based ceramic precursor material) comprises mechanically crushing the compacted body to form a plurality of particles. A compacted body can be converted into smaller sized particles (e.g., abrasive grain precursor material particles) by any suitable conventional means (e.g., by crushing). Crushing or comminuting methods known in the art include hammer milling, roll crushing, pulverizing, and ball milling. It is much easier and requires significantly less energy to crush the compacted body than it does to crush calcined or sintered ceramic material. Since there will typically be 20% to 40% shrinkage by volume on sintering, the crushed material should be slightly larger than the desired grain. In some cases, the final alpha alumina-based ceramic material is in a form of a plurality of abrasive grains.

In some cases, the converting in step b) (i.e., converting the compacted body to an alpha alumina-based ceramic precursor material) comprises calcining the compacted body. In general, techniques for calcining the compacted body, plurality of particles, or impregnated alpha alumina ceramic precursor material, are known in the art. During the calcining essentially all the volatiles are removed, and any oxide precursors are transformed into oxides. Such techniques include using a rotary or static furnace to heat the material at temperatures ranging from about 400-1000 degrees Celsius (° C.) (typically from about 500-800° C.) until the free water, and typically until at least about 90 percent by weight of any bound volatiles are removed.

One skilled in the art, after reviewing the disclosure herein, may be able to select other techniques for calcining, as well as select appropriate conditions such as calcining temperature(s), calcining time(s), calcining rate(s), (including the heating and/or cooling rate(s)), environment(s) (including relative humidity, pressure (i.e., atmospheric pressure or a pressure above or below the atmospheric pressure)), and/or the component(s) making up the calcining atmosphere, other than those specifically provided herein. The more suitable calcining conditions may depend, for example, on one or more of the following: the components of the material (e.g., compacted body), the amounts, or relative amounts of the components of the material, the particle sizes of the components of the material, and/or the particle size distribution of the components of the material), the calcining temperature(s), the calcining time(s), the calcining rates(s), and the component(s) making up the calcining atmosphere).

Preferred calcining temperatures are typically not greater than 800° C. (more typically in the range from about 500° C. to about 800° C. (such as about 600° C. to about 700° C.). Temperatures below about 500° C. may be useful, but typically require longer calcining times. It may, however, be desirable to utilize several different calcining conditions (including different temperatures) wherein, for example, the material is partially calcined for a time at a temperature(s) below about 500° C., and then further calcined at a temperature(s) above about 600° C. Temperatures above about 800° C. may also be useful but tend to reduce the surface area of the alumina and thus decrease its reactivity. Heating for the calcining step, which can be done, for example, using electrical resistance or gas, can be on a batch basis or on a continuous basis.

Typically, a suitable impregnation composition comprises a mixture comprising liquid medium and metal oxide, and/or precursors thereof, and, optionally, nucleating material). In general, methods of impregnating particles are described, for example, in U.S. Pat. No. 5,164,348 (Wood), the disclosure of which is incorporated herein by reference.

Typically, ceramic precursor material, or calcined ceramic precursor material is porous. For example, a calcined ceramic precursor material generally has pores about 5-10 nanometers in diameter extending therein from an outer surface. The presence of such pores allows an impregnation composition comprising a mixture comprising liquid medium and appropriate metal oxide and/or precursor (preferably metal salts such as the metal nitrate, acetate, citrate, and formate salts) to enter into, or in the case of particulate material on the surface of, the ceramic precursor material. It is also contemplated to impregnate with an aluminum salt, although typically the impregnate is a salt other than an aluminum salt. The metal salt material is dissolved in a liquid medium, and the resulting solution contacted with the compacted body or mixed with the ceramic precursor particle material. The impregnation process is thought to occur through capillary action. The impregnation process can be improved by subjecting the porous ceramic precursor material to vacuum treatment before or during the mixing step.

The liquid media used for the impregnating composition is preferably water (including deionized water) and/or an organic solvent (preferably a non-polar solvent). If the material is calcined prior to the impregnation step, water is the preferred liquid media for the impregnation composition. If the material is not calcined prior to the impregnation step, the liquid media preferred is one that will not dissolve or soften the material.

The concentration of the metal salt in the liquid medium is typically in the range from about 5% to about 40% dissolved solids, on a theoretical metal oxide basis. In general, there should be at least 50 milliliters (mL) of solution added to achieve impregnation of 100 grams of porous ceramic precursor material, preferably, at least about 60 mL of solution to 100 grams of ceramic precursor material.

In some instances, more than one impregnation step may be utilized. The same impregnation composition may be applied in repeated treatments, or subsequent impregnation compositions may contain different concentrations of the same salts, different salts, or different combinations of salts. Further, it is contemplated to, for example, first impregnate the calcined precursor material with an impregnation composition comprising a mixture comprising liquid (e.g., water) and an acidic metal salt, and then further impregnate with a second impregnation composition comprising a mixture comprising liquid (e.g., water) and a base or basic salt (e.g., NH₄OH). Although not wanting to be bound by theory, it is believed that the second impregnation of the base or basic salt causes the impregnated acidic metal oxide precursor(s) to precipitate thereby reducing migration of the metal oxide precursors. For further details regarding multiple impregnations involving acidic and basic materials see, for example, U.S. Pat. No. 5,164,348 (Wood) and U.S. Pat. No. 5,527,369 (Garg), the disclosures of which are incorporated herein by reference.

In another aspect, the impregnation composition may be comprised of a mixture comprising liquid, an acidic metal salt and a base precursor (e.g., urea, formamide, acetamide, hydroxlamine, and methylamine), wherein the latter decomposes on heating to yield a base. Again, although not wanting to be bound by theory, it is believed that the base causes the impregnated acidic metal salt to precipitate thereby reducing migration of the metal oxide precursors.

In certain embodiments, the impregnating composition comprises a liquid medium and at least one metal oxide precursor selected from the group consisting of magnesium nitrate, cobalt nitrate, nickel nitrate, iron nitrate, lithium nitrate, manganese nitrate, chromium nitrate, yttrium nitrate, samarium nitrate, neodymium nitrate, lanthanum nitrate, gadolinium nitrate, dysprosium nitrate, europium nitrate, zinc nitrate, zirconium nitrate, zirconyl acetate, magnesium acetate, cobalt acetate, nickel acetate, lithium acetate, manganese acetate, chromium acetate, yttrium acetate, praseodymium acetate, samarium acetate, ytterbium acetate, neodymium acetate, lanthanum acetate, gadolinium acetate, dysprosium acetate, magnesium citrate, cobalt citrate, lithium citrate, manganese citrate, magnesium formate, cobalt formate, lithium formate, manganese formate, and nickel formate, and combinations thereof.

Additional details regarding the impregnation of porous, calcined alpha alumina-based precursor are described in U.S. Pat. No. 6,206,942 (Wood), the disclosure of which is incorporated herein by reference.

In some cases, the converting in step d) (i.e., converting the impregnated alpha alumina-based ceramic precursor material) comprises sintering the impregnated alpha alumina-based ceramic precursor material.

In general, techniques for sintering the calcined or impregnated ceramic precursor material, which include heating at a temperature effective to transform transitional alumina(s) into alpha alumina, to causing all of the metal oxide precursors to either react with the alumina or form metal oxide, and increasing the density of the ceramic material, are known in the art. As used herein, transitional alumina is any crystallographic form of alumina that exists after heating the hydrated alumina to remove the water of hydration prior to transformation to alpha alumina (e.g., eta, theta, delta, chi, iota, kappa, and gamma forms of alumina and intermediate combinations of such forms). The calcined material can be sintered, for example, by heating (e.g., using electrical resistance, plasma, microwave, laser, or gas combustion, on a batch basis (e.g., using a static furnace) or a continuous basis (e.g., using a rotary kiln)) at temperatures ranging from about 1200° C. to about 1650° C. (typically, from about 1200° C. to about 1550° C., more typically, from about 1300° C. to about 1450° C., or even from about 1350° C. to about 1450° C.). The length of time which the calcined material is exposed to the sintering temperature depends, for example, on material size, composition of the material, and sintering temperature. Typically, sintering times range from a few seconds to about 60 minutes (e.g., within about 3-30 minutes). Sintering is typically accomplished in an oxidizing atmosphere, although neutral (e.g., argon or nitrogen) or reducing atmospheres (e.g., hydrogen or forming gas) may also be useful.

One skilled in the art, after reviewing the disclosure herein, may be able to select other techniques for sintering the calcined material, as well as select appropriate conditions such as sintering temperature(s), sintering time(s), sintering rate(s), (including the heating and/or cooling rate(s)), environment(s) (including relative humidity, pressure (i.e., atmospheric pressure or a pressure above or below the atmospheric pressure), and/or the component(s) making up the sintering atmosphere), other than those specifically provided herein. The more suitable sintering conditions may depend, for example, on one or more of the following: the particular material (e.g., the components of the material, the amounts, or relative amounts of the components of the material, the particle sizes of the components of the material, and/or the particle size distribution of the components of the material), the sintering temperature(s), the sintering time(s), the sintering rates(s), and the component(s) making up the sintering atmosphere).

It may, however, be desirable to utilize several different sintering conditions (including different temperatures) wherein, for example, the calcined or ceramic precursor material is partially sintered for a time at a temperature(s) below 1200° C., and then further sintered at a temperature(s) above 1350° C. Additional details regarding sintering can be found, for example, in U.S. Pat. No. 4,314,827 (Leitheiser et al.) and U.S. Pat. No. 5,489,204 (Conwell et al.), and U.S. Pat. No. 5,653,775 (Plovnick et al.) the disclosures of which are incorporated herein by reference.

Sintered alpha alumina-based ceramic material made according to the present disclosure typically comprises, on a theoretical metal oxide basis, 95, 98, or even 99 percent by weight Al₂O₃, based on the total weight of the ceramic material, and has a Vickers hardness of at least about 16 gigapascals (GPa), such as at least about 18 GPa, 19 GPa, or at least about 20 GPa.

In some cases, the converting in step d) (i.e., converting the impregnated alpha alumina-based ceramic precursor material) further comprises calcining the impregnated alpha alumina-based ceramic precursor material prior to sintering the impregnated alpha alumina-based ceramic precursor material. The calcining may be performed as in any embodiment described above with respect to calcining the compacted body.

The final alpha alumina-based ceramic material may be according to any of the embodiments according to the first aspect described above in detail.

### EMBODIMENTS

In a first embodiment, the present disclosure provides an alpha alumina-based ceramic material. The alpha alumina-based ceramic material comprises a plurality of domains comprising alpha alumina and a reaction product of alumina and at least one metal oxide different from alumina. The domains comprise a shortest dimension of 5 to 80 micrometers. The alpha alumina-based ceramic material exhibits a density of greater than 90% of theoretical.

In a second embodiment, the present disclosure provides an alpha alumina-based ceramic material according to the first embodiment, having a form of a plurality of abrasive grains.

In a third embodiment, the present disclosure provides an alpha alumina-based ceramic material according to the second embodiment, wherein the abrasive grains have conchoidal fractures.

In a fourth embodiment, the present disclosure provides an alpha alumina-based ceramic material according to the second embodiment or the third embodiment, wherein the abrasive grains have an average particle size from 0.5 millimeters (mm) to 5 mm.

In a fifth embodiment, the present disclosure provides an alpha alumina-based ceramic material according to any of the first through fourth embodiments, wherein the reaction product of alumina and the at least one metal oxide different from alumina is present in an amount greater than 0.5 percent metal oxide, based on a total oxide content of the alpha alumina-based ceramic material.

In a sixth embodiment, the present disclosure provides an alpha alumina-based ceramic material according to any of the first through fifth embodiments, wherein the metal oxide is selected from the group consisting of MgO, CoO, NiO, Ce₂O₃, ZrO₂, HfO₂, Li₂O, MnO, Cr₂O₃, Y₂O₃, Pr₂O₃, Sm₂O₃, Yb₂O₃, Nd₂O₃, La₂O₃, Gd₂O₃, Dy₂O₃, Er₂O₃, Eu₂O₃, TiO₂, Fe₂O₃, SnO₂, ZnO, ZrO₂, and combinations thereof.

In a seventh embodiment, the present disclosure provides an alpha alumina-based ceramic material according to any of the first through sixth embodiments, wherein the metal oxide is a combination of MgO, La₂O₃, and Y₂O₃.

In an eighth embodiment, the present disclosure provides an alpha alumina-based ceramic material according to any of the first through seventh embodiments, exhibiting a density of greater than 94%, 95%, 96%, or greater than 97% of theoretical.

In a ninth embodiment, the present disclosure provides a method of making an alpha alumina-based ceramic material. The method comprises pressing aluminum hydroxide precursor powder selected from the group consisting of boehmite powder, gibbsite powder, bayerite powder, and combinations thereof, under applied pressure of greater than 5 kilopounds per square inch (ksi) (34 megapascals (MPa)), thereby forming a compacted body, and converting the compacted body to an alpha alumina-based ceramic precursor material. The method further comprises impregnating the alpha alumina-based ceramic precursor material with an impregnating composition comprising at least one metal oxide precursor, at least one metal oxide, or any combinations thereof, and converting the impregnated alpha alumina-based ceramic precursor material to an alpha alumina-based ceramic material. The alpha alumina-based ceramic material exhibits a density of greater than 90% of theoretical.

In a tenth embodiment, the present disclosure provides a method of making an alpha alumina-based ceramic material according to the ninth embodiment, wherein the converting in step b) comprises calcining the compacted body.

In an eleventh embodiment, the present disclosure provides a method of making an alpha alumina-based ceramic material according to the ninth embodiment or the tenth embodiment, wherein the converting in step b) comprises mechanically crushing the compacted body to form a plurality of particles.

In a twelfth embodiment, the present disclosure provides a method of making an alpha alumina-based ceramic material according to the eleventh embodiment, wherein the alpha alumina-based ceramic material is in a form of a plurality of abrasive grains.

In a thirteenth embodiment, the present disclosure provides a method of making an alpha alumina-based ceramic material according to any of the ninth through twelfth embodiments, wherein the converting in step d) comprises sintering the impregnated alpha alumina-based ceramic precursor material.

In a fourteenth embodiment, the present disclosure provides a method of making an alpha alumina-based ceramic material according to the thirteenth embodiment, wherein the converting in step d) further comprises calcining the impregnated alpha alumina-based ceramic precursor material prior to sintering the impregnated alpha alumina-based ceramic precursor material.

In a fifteenth embodiment, the present disclosure provides a method of making an alpha alumina-based ceramic material according to any of the ninth through fourteenth embodiments, wherein the impregnating composition comprises a liquid medium and at least one metal oxide precursor selected from the group consisting of magnesium nitrate, cobalt nitrate, nickel nitrate, iron nitrate, lithium nitrate, manganese nitrate, chromium nitrate, yttrium nitrate, samarium nitrate, neodymium nitrate, lanthanum nitrate, gadolinium nitrate, dysprosium nitrate, europium nitrate, zinc nitrate, zirconium nitrate, zirconyl acetate, magnesium acetate, cobalt acetate, nickel acetate, lithium acetate, manganese acetate, chromium acetate, yttrium acetate, praseodymium acetate, samarium acetate, ytterbium acetate, neodymium acetate, lanthanum acetate, gadolinium acetate, dysprosium acetate, magnesium citrate, cobalt citrate, lithium citrate, manganese citrate, magnesium formate, cobalt formate, lithium formate, manganese formate, and nickel formate, and combinations thereof.

In a sixteenth embodiment, the present disclosure provides a method of making an alpha alumina-based ceramic material according to any of the ninth through fifteenth embodiments, wherein the applied pressure is 30 ksi (207 MPa) or greater.

In a seventeenth embodiment, the present disclosure provides a method of making an alpha alumina-based ceramic material according to any of the ninth through sixteenth embodiments, wherein the alpha alumina-based ceramic material is according to any of the first through eighth embodiments.

### EXAMPLES

Unless otherwise noted or apparent from the context, all parts, percentages, ratios, etc. in the Examples and the rest of the specification are by weight. The following abbreviations are used in this section: g=grams, m=meters, mm=millimeters, ksi=thousand pounds per square inch, MPa=megaPascals, ° C.=degrees Celsius, h=hours, min=minutes, cc=cubic centimeters, FE-SEM-field emission scanning electron microscope, rpm=revolutions per minute.

TABLE 1
Materials Used in the Examples

| Abbreviation | Description and Source |
|---|---|
| BOEHMITE A | Boehmite powder available under the trade designation |
| | “CATAPAL B” from Sasol, Houston, TX |
| BOEHMITE B | Boehmite powder available under the trade designation |
| | “DISPERAL P2” from Sasol |
| BOEHMITE C | Boehmite powder available under the trade designation |
| | “DISPAL 23C9” from Sasol |
| BOEHMITE D | Boehmite powder available under the trade designation |
| | “DISPAL 25F4” from Sasol |
| BOEHMITE E | Boehmite powder available under the trade designation |
| | “DISPERAL” from Sasol |
| BOEHMITE F | Boehmite powder available under the trade designation |
| | “950” from PIDC, Ann Arbor, MI |
| REO | A solution of a mixture of La(NO₃)₃/Y(NO₃)₃, Nd(NO₃)₃ |
| SOLUTION | and Mg(NO₃)₃ salts as described in U.S. Pat. No. |
| | 10,987,780 (col. 18, lines 14 through 16) |

### Test Methods

### Density Measured by He Pycnometer

Density of the samples was measured using a gas pycnometer available under the trade designation “ACCUPYC 1340” from Micromeritics, Norcross, GA, utilizing 3.5 cc measuring cup.

### Percent of Theoretical Density

Geometric density was determined by dividing mass of a material measured using conventional balance by volume of the material measured using calipers. Percent of Theoretical Density (% th) was determined by normalizing geometrical density by Density Measured by He Pycnometer.

### EXAMPLES

### Example 1 (EX-1)

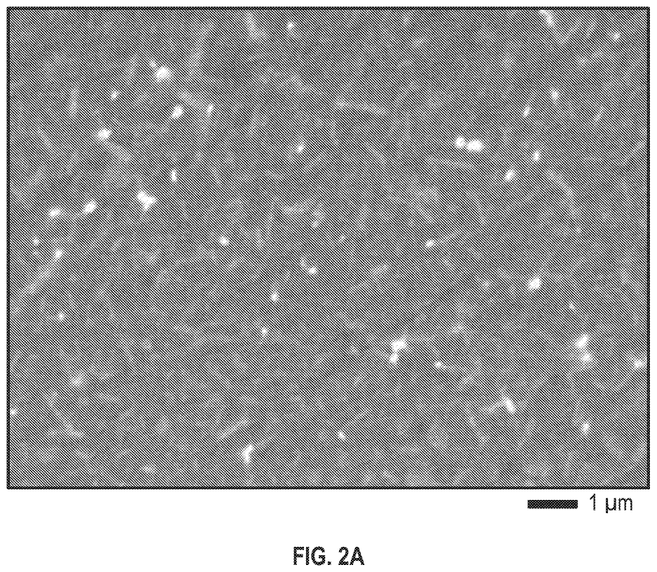

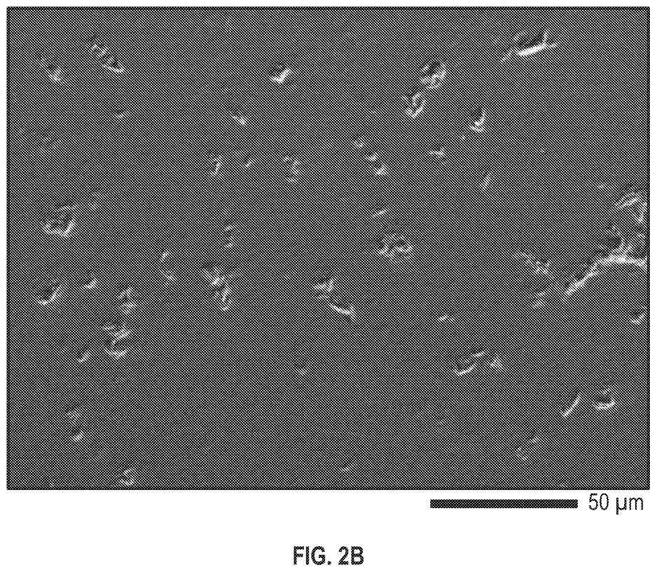

2 g of BOEHMITE A was placed in a stainless steel die (13 mm diameter) and pressed uniaxially at 75 ksi (517 MPa) of applied pressure. A translucent pellet with of approximately 1.1 mm thickness was obtained. The pellet was subsequently calcined at 700° C. for 1 h at a heating rate of 5° C./min. Infiltration with REO SOLUTION was then performed. The pellet was then calcined again at 700° C. for 1 h and subjected to final firing (i.e., sintering) at 1420° C. for 30 min, inserting the pellet directly into the hot zone. The density measured by He pycnometer was 3.87 g/cc. Presented in FIGS. 2A and 2B are images of Example 1 material collected by FE-SEM.

### Examples 2 Through 5 (EX-2 Through EX-5)

For each of Examples 2 through 5, 2 g of BOEHMITE A was placed in a stainless steel die (13 mm diameter) and pressed uniaxially at applied pressures as indicated in Table 2, below. The Percent of Theoretical Density are also presented in Table 2.

TABLE 2
Characterization

| | Applied Pressure | Applied Pressure | Density |
|---|---|---|---|
| Example | (ksi) | (MPa) | (% th) |
| EX-2 | 12 | 82.7 | 44.5 |
| EX-3 | 24 | 165.4 | 48 |
| EX-4 | 48 | 330.8 | 62.5 |
| EX-5 | 84 | 661.6 | 78 |

### Examples 6 Through 11 (EX-6 Through EX-11)

For each of EX-6 through EX-11, 20 g of the powder indicated in Table 3 was placed in a stainless steel die (33 mm diameter) and pressed uniaxially at 30 ksi (206 MPa) of applied pressure. Calcining, infiltrating with REO SOLUTION, and sintering was then carried out as described in Example 1. Densities Measured by He Pycnometry according to the procedure above are presented in Table 3.

TABLE 3
Sample Description and Characterization

| Example | | |
|---|---|---|
| Number | Powder | Density (g/cc) |
| EX-6 | BOEHMITE B | 3.924 |
| EX-7 | BOEHMITE A | 3.884 |
| EX-8 | BOEHMITE C | 3.857 |
| EX-9 | BOEHMITE D | 3.7966 |
| EX-10 | BOEHMITE E | 3.866 |
| EX-11 | BOEHMITE F | 3.823 |

### Example 12 (EX-12)

500 g of BOEHMITE C was placed in a rubber bag, sealed, and cold isostatically pressed (CIP) at 55 ksi (~379.2 MPa) of applied pressure. A cylindrical green body was obtained. Subsequently, the green body was mechanically crushed using a mortar and pestle to generate particles with sizes less than −14 mesh. The particles were calcined at 700° C. for 1 h heating at a rate of 5° C./min. Infiltration with REO SOLUTION was then performed. The particles were then calcined again at 700° C. for 1 h and subjected to final firing (i.e., sintering) at 1325° C. for 30 min. The sample was directly placed into the hot zone. The Density Measured by He Pycnometer was 3.86 g/cc. Images of EX-12 collected by FE-SEM are presented in FIGS. 1A-1C. Subsequently, the particles were screened to separate fractions consisting of −25+35 mesh and −35+45 mesh particles (i.e., around 1 mm) using conventional sieves obtained from W.S. Tyler corporation, Mentor, OH. Equal weights of these two size fractions were blended for performance testing.

### Example 13 (EX-13) and Comparative Example 14 (CE-14)

For EX-13, approximately 12 grams of abrasive particles prepared as EX-12 were incorporated into a coated abrasive disc. The coated abrasive disc was made according to conventional procedures. The abrasive particles were bonded to 17.8 cm diameter, 0.8 mm thick vulcanized fiber backings (having a 2.2 cm diameter center hole) using a conventional calcium carbonate-filled phenolic make resin (48% resole phenolic resin, 52% calcium carbonate, diluted to 81% solids with water and glycol ether) and a conventional cryolite-filled phenolic size resin (32% resole phenolic resin, 2% iron oxide, 66% cryolite, diluted to 78% solids with water and glycol ether). The wet make resin weight was about 185 g/m². Immediately after the make coat was applied, the abrasive particles were electrostatically coated. The make resin was heated for 120 min at 88° C. Then, the cryolite-filled phenolic size coat was coated over the make coat and abrasive particles. The wet size weight was about 850 g/m². The size resin was heated for 12 hours at 99° C. The coated abrasive disc was flexed prior to testing. For CE-14, a coated abrasive disc was prepared as described above for EX-13, with the exception that crushed sol-gel-derived abrasive particles (available under the trade designation 3M CERAMIC ABRASIVE GRAIN 321 from the 3M Company, St. Paul, Minnesota) was used in place of the EX-12 abrasive particles.

The grinding performance of EX-13 and CE-14 coated abrasive discs were evaluated as follows. Each coated abrasive disc was mounted on a beveled aluminum back-up pad and used to grind the face of a pre-weighed 1.25 cm×18 cm×10 304 stainless steel workpiece. The disc was driven at 5,000 rpm while the portion of the disc overlaying the beveled edge of the back-up pad contacted the workpiece at a load of 8.6 kilograms. Each disc was used to grind an individual workpiece in sequence for one-minute intervals. The total cut was the sum of the amount of material removed from the workpiece throughout the test period. The total cut by each sample after 40 cycles of grinding is reported in Table 4, below.

TABLE 4
Characterization

| Example Number | Total Cut (g) |
|---|---|
| CE-14 | 248 |
| EX-13 | 253 |

Although the present invention has been described with reference to preferred embodiments, workers skilled in the art will recognize that changes may be made in form and detail without departing from the spirit and scope of the disclosure.

1. An alpha alumina-based ceramic material comprising a plurality of domains comprising alpha alumina and a reaction product of alumina and at least one metal oxide different from alumina, the domains comprising a shortest dimension of 5 to 80 micrometers, wherein the alpha alumina-based ceramic material exhibits a density of greater than 90% of theoretical.

2. The alpha alumina-based ceramic material of claim 1, having a form of a plurality of abrasive grains.

3. The alpha alumina-based ceramic material of claim 2, wherein the abrasive grains have conchoidal fractures.

4. The alpha alumina-based ceramic material of claim 2, wherein the abrasive grains have an average particle size from 0.5 millimeters (mm) to 5 mm.

5. The alpha alumina-based ceramic material of claim 1, wherein the reaction product of alumina and the at least one metal oxide different from alumina is present in an amount greater than 0.5 percent metal oxide, based on a total oxide content of the alpha alumina-based ceramic material.

6. The alpha alumina-based ceramic material of claim 1, wherein the metal oxide is selected from the group consisting of MgO, CoO, NiO, Ce₂O₃, ZrO₂, HfO₂, Li₂O, MnO, Cr₂O₃, Y₂O₃, Pr₂O₃, Sm₂O₃, Yb₂O₃, Nd₂O₃, La₂O₃, Gd₂O₃, Dy₂O₃, Er₂O₃, Eu₂O₃, TiO₂, Fe₂O₃, SnO₂, ZnO, ZrO₂, and combinations thereof.

7. The alpha alumina-based ceramic material of claim 1, wherein the metal oxide is a combination of MgO, La₂O₃, and Y₂O₃.

8. The alpha alumina-based ceramic material of claim 1, exhibiting a density of greater than 94% of theoretical.

9. A method of making an alpha alumina-based ceramic material, the method comprising:
a) pressing aluminum hydroxide precursor powder selected from the group consisting of boehmite powder, gibbsite powder, bayerite powder, and combinations thereof, under applied pressure of greater than 5 kilopounds per square inch (ksi) (34 megapascals (MPa)), thereby forming a compacted body;
b) converting the compacted body to an alpha alumina-based ceramic precursor material;
c) impregnating the alpha alumina-based ceramic precursor material with an impregnating composition comprising at least one metal oxide precursor, at least one metal oxide, or any combinations thereof; and
d) converting the impregnated alpha alumina-based ceramic precursor material to an alpha alumina-based ceramic material,
wherein the alpha alumina-based ceramic material exhibits a density of greater than 90% of theoretical and wherein the alpha alumina-based ceramic material comprises a plurality of domains comprising alpha alumina and a reaction product of alumina and at least one metal oxide different from alumina, the domains comprising a shortest dimension of 5 to 80 micrometers.

10. The method of claim 9, wherein the converting in step b) comprises calcining the compacted body.

11. The method of claim 9, wherein the converting in step b) comprises mechanically crushing the compacted body to form a plurality of particles.

12. The method of claim 11, wherein the alpha alumina-based ceramic material is in a form of a plurality of abrasive grains.

13. The method of claim 9, wherein the converting in step d) comprises sintering the impregnated alpha alumina-based ceramic precursor material.

14. The method of claim 13, wherein the converting in step d) further comprises calcining the impregnated alpha alumina-based ceramic precursor material prior to sintering the impregnated alpha alumina-based ceramic precursor material.

15. The method of claim 9, wherein the impregnating composition comprises a liquid medium and at least one metal oxide precursor selected from the group consisting of magnesium nitrate, cobalt nitrate, nickel nitrate, iron nitrate, lithium nitrate, manganese nitrate, chromium nitrate, yttrium nitrate, samarium nitrate, neodymium nitrate, lanthanum nitrate, gadolinium nitrate, dysprosium nitrate, europium nitrate, zinc nitrate, zirconium nitrate, zirconyl acetate, magnesium acetate, cobalt acetate, nickel acetate, lithium acetate, manganese acetate, chromium acetate, yttrium acetate, praseodymium acetate, samarium acetate, ytterbium acetate, neodymium acetate, lanthanum acetate, gadolinium acetate, dysprosium acetate, magnesium citrate, cobalt citrate, lithium citrate, manganese citrate, magnesium formate, cobalt formate, lithium formate, manganese formate, and nickel formate, and combinations thereof.

16. The method of claim 9, wherein the applied pressure is 30 ksi (207 MPa) or greater.

17. The method of claim 9, wherein the alpha alumina-based ceramic material is according to claim 1.
